(19) United States
(12) Patent Application Publication
(10) Pub. No.: US 2017/0202205 A1
(43) Pub. Date: Jul. 20, 2017

(54) Mouse trap

(71) Applicant: Guodong WU, Wenzhou (CN)

(72) Inventor: Guodong WU, Wenzhou (CN)

(21) Appl. No.: 15/408,441

(22) Filed: Jan. 18, 2017

(30) Foreign Application Priority Data
Jan. 18, 2016 (CN) 201610030113.5

(51) Int. Cl. A01M 23/18; A01M 23/12; G01J 5/00; E05F 15/78; E05F 15/73; A01M 23/08; A01M 99/00

(52) U.S. Cl. CPC A01M 23/18; A01M 23/08; A01M 23/12; A01M 99/00; E05F 15/78; E05F 15/73; G01J 5/0025; E05F 2015/765

(57) ABSTRACT

The invention discloses a mouse trap, including a mouse luring chamber and a mouse trapping chamber, the mouse luring chamber and the mouse trapping chamber are designed integrally and divided by a partition plate. The mouse luring chamber includes guiding rods, an automatic door, a clamp frame, a bait box, an infrared thermal sensor, a horizontal rod. The mouse trapping chamber includes a mouse guiding channel, a first door, a second door, an outer frame, a first electric motor, a take-up pulley, first pulling strings, a second electric motor, a linkage piece, and a mouse storage chamber. The mouse storage chamber includes a third door and a block rod. The advantages of the invention are provided as below: it has a new structure and easy to operate. It can trap several mice automatically and has a good captivity and trapping effects.

### CROSS REFERENCE

This application claims priority to a Chinese application CN201610030113,5 fled on Jan. 18, 2016, the entire content of which is incorporated herein by reference.

### TECHNICAL FIELD

The present invention relates to a mouse trap.

### BACKGROUND

Mice or rats are rodents of different sizes and various types, in total about 280 genera and at least 1300 species. There are a large number of mice which breed very quickly and grow vigorously. A mouse can eat almost anything and live anywhere. In addition, it can make holes, climb up the trees, wade through the water, as well as waste foods and spread diseases, which is very harmful to the human beings. Apart from the natural enemy, the human beings also kill mice with special apparatuses, such as a mouse trap, a mouse cage, an electronic mouse trap, a glue trap, poisonous bait box, etc. and raticide. The natural enemy of the mouse is cat.

Due to the harm to the life of the human beings and inconvenience brought by the mouse, for example, the clothes chewed away and the holes made in bins by the mouse, the human beings figure out various ways to trap the mouse. However, most of the trap devices made by the human beings can trap only one mouse once. If one mouse is trapped, due to its strong memory and food resistance, the mouse is on the alert if the familiar environment partly changes. The mouse hangs back and will move forward after repeated attempts. If the mouse is attacked somewhere, it will avoid this location and the other mice will no longer pass by this location either, which is difficult for trapping, the mice once again. Additionally, the mouse needs to be taken out manually after it is caught in the mouse trapping apparatus, which is troublesome and unsafe, due to being easily bitten by the mouse.

### SUMMARY

To solve the above problems of a limited number of mice trapped, etc., the present invention is aimed to provide a mouse trap with a new structure. It is easy to operate and can trap several mice automatically, and has a good captivity and trapping effects.

To achieve the purpose, the technical solutions of the present invention are provided as below:

A mouse trap, includes a mouse luring chamber and a mouse trapping chamber, the mouse luring chamber and the mouse trapping chamber are designed integrally and divided by a partition plate. The edges of the mouse luring chamber and the mouse trapping chamber are connected by L-shaped bordures, and a cage wall is provided at all sides of the mouse luring chamber and the mouse trapping chamber. There are openings in the two sides of the mouse luring chamber and guiding rods are welded at two sides of the openings. An automatic door is provided between the guiding rod and the L-shaped bordures. An L-shaped flexible piece is welded on the automatic door. An end of the flexible piece is welded onto the automatic door, and the other end of the flexible piece goes through the other side of the automatic door. The bottom of the mouse luring chamber is open and an iron wire is welded to the bottom. The infrared thermal sensor is provided on the partition plate and is fixed by a connector. An infrared hole is provided in the partition plate under the infrared thermal sensor. A clamp frame is welded onto the inner side of the mouse luring chamber. A bait box is provided inside the clamp frame. A mesh is provided on one side of the bait box. A pulley is provided at an upper end of the mouse trapping chamber, and a wire stand is provided below the pulley. An entrance is provided in the partition plate between the mouse luring chamber and the mouse trapping chamber. A mouse guiding channel is welded inside the mouse trapping chamber. An end of the mouse guiding channel is an inlet and a first door is rotationally installed at the inlet by a horizontal rod. An upturned piece is provided on the other side of the first door parallel to the horizontal rod. The upturned piece and the first door are arranged at an angle over 90 degrees. There are gaps between the upturned piece and one side of the first door, and between the one side of the first door and the cage wall. The one side of the first door is placed on a limiting piece on the cage wall. An extended piece extends from the other side of the first door. A second door is rotationally connected to the mouse guiding channel. A first brace rod is welded onto the second door. The first brace rod goes upward and through the mouse guiding channel and contacts a switch. A baffle plate is provided in the mouse guiding channel at a front end of the second door. A cage placement opening is provided in the side face of the mouse trapping chamber. Several guiding rails are provided inside the mouse trapping chamber and correspond to the cage placement opening. A mouse storage chamber is placed into the cage placement opening through guiding rails. An opening is provided on one side of the mouse storage chamber. A round rod is provided above the opening. A third door is rotationally connected to the round rod. A block rod is rotationally connected to an inner wall of the mouse storage chamber. A block rod goes outside of the mouse storage chamber through a groove. An outer frame is provided on an upper surface of the mouse guiding channel. A power supply is provided beside the outer frame. A first electric motor is provided inside outer frame. Sleeved rod is connected to the first electric motor, and a sleeved rod is locked into a sleeve-block rod. A take-up pulley is provided on the sleeved rod. A limit switch is installed on the outer frame beside the take-up pulley. A second brace rod is provided on the limit switch. Two first pulling strings are connected to the take-up pulley. A bead is provided on the first pulling string on the side of the mouse storage chamber. Two first pulling strings go through the pulley and the wire stand, and then are connected to a flexible piece on the automatic door. A vertical piece is further provided on the outer frame. A middle portion of a linkage piece is connected to the vertical piece. One end of the linkage piece is connected to a second pulling string, and the other end of the linkage piece is located below the take-up pulley. A U-shaped limit sleeved rod is provided on the outer frame at a junction of the linkage piece and the second pulling string. The linkage piece goes through the limit sleeved rod. A torsion spring is connected to a junction of the linkage piece and the vertical piece. One end of the torsion spring presses against the linkage piece, and the other end of the torsion spring is caught by the vertical piece. One end of the second pulling string is connected to the linkage piece, and the other end of the second pulling string is connected to a reel rod on a second electric motor on a lower surface of the outer frame. A start switch is provided on a surface of the cage wall.

Preferably, the mouse trapping chamber and the mouse storage chamber are both provided with handles.

Preferably, the flexible piece is in a shape of “L” and a base line of is within edges of the partition plate.

Preferably, the mouse guiding channel corresponds to the opening of the mouse storage chamber at the second door.

Preferably, the block rod contacts a third door.

Preferably, the first pulling string at the limit switch goes through the second brace rod.

Preferably, the linkage piece is rotationally connected to the vertical piece.

Preferably, wires are provided between the infrared thermal sensor and the second electric motor, between the limit switch and the first electric motor, between the limit switch and the second electric motor, between the start switch and the first electric motor, between the switch and the first electric motor, between the power supply and the second electric motor, and between the power supply and the first electric motor.

Preferably, a fourth door is hinged to the mouse trapping chamber above the outer frame.

The advantages of the invention are provided as below: it has a new structure and easy to operate. It can trap several mice automatically and has a good captivity and trapping effects.

### BRIEF DESCRIPTION OF THE DRAWINGS

FIG. 1 is the structural schematic diagram of the present invention;

FIG. 2 is the structural schematic diagram of the present invention removing the cage wall;

FIG. 3 is the structural schematic diagram of the mouse guiding channel of the present invention;

FIG. 4 is the structural schematic diagram of the first door of the present invention;

FIG. 5 is the structural schematic diagram of the outer frame and the take-up pulley of the present invention;

FIG. 6 is the structural schematic diagram of the lower surface of the outer frame of the present invention;

FIG. 7 is the structural schematic diagram of the mouse storage chamber of the present invention;

FIG. 8 is the structural schematic diagram of the automatic door of the present invention;

FIG. 9 is the structural schematic diagram of the pedal of the present invention;

FIG. 10 is the top view of the partition plate of the present invention.

### DETAILED DESCRIPTION

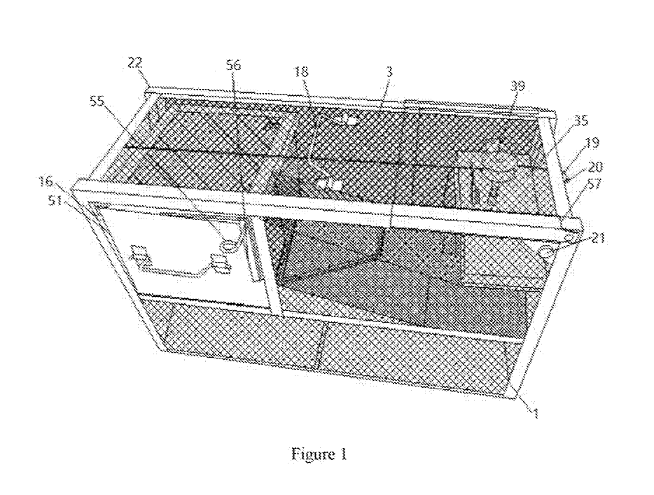

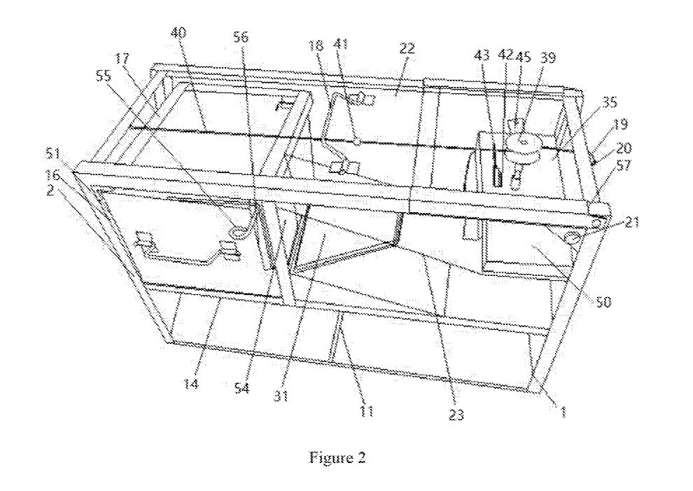

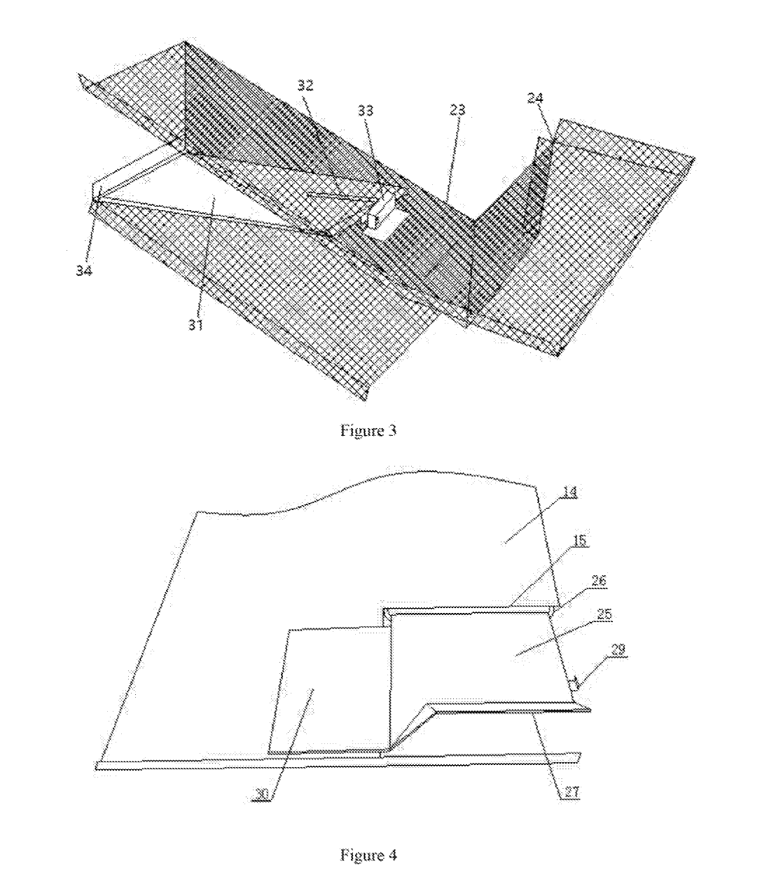

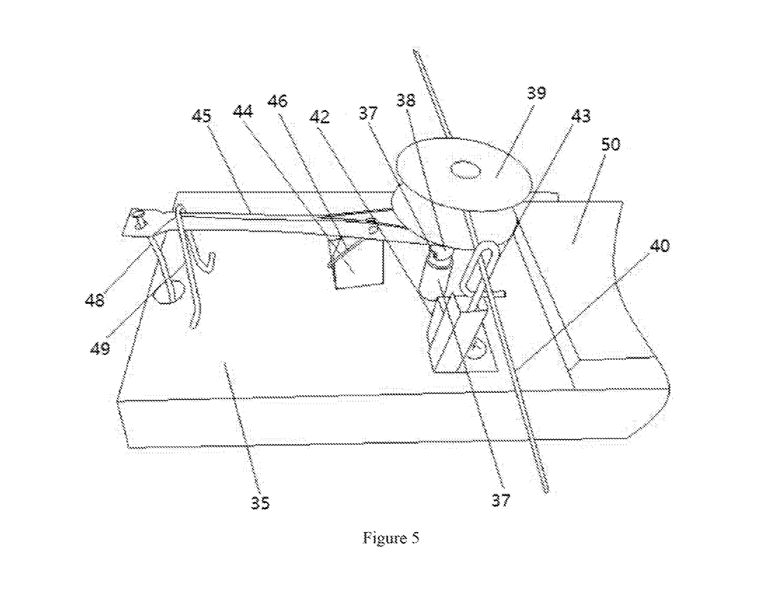

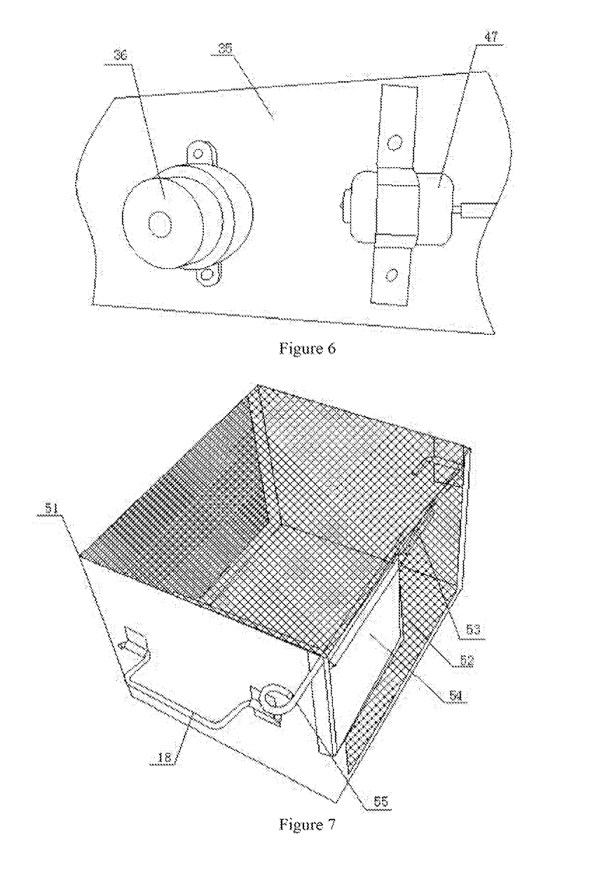

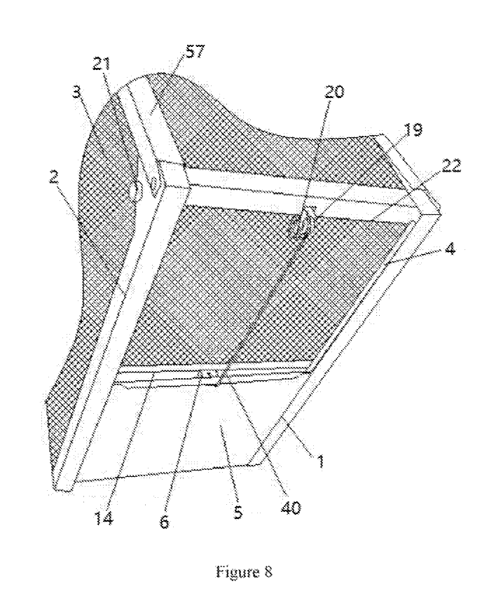

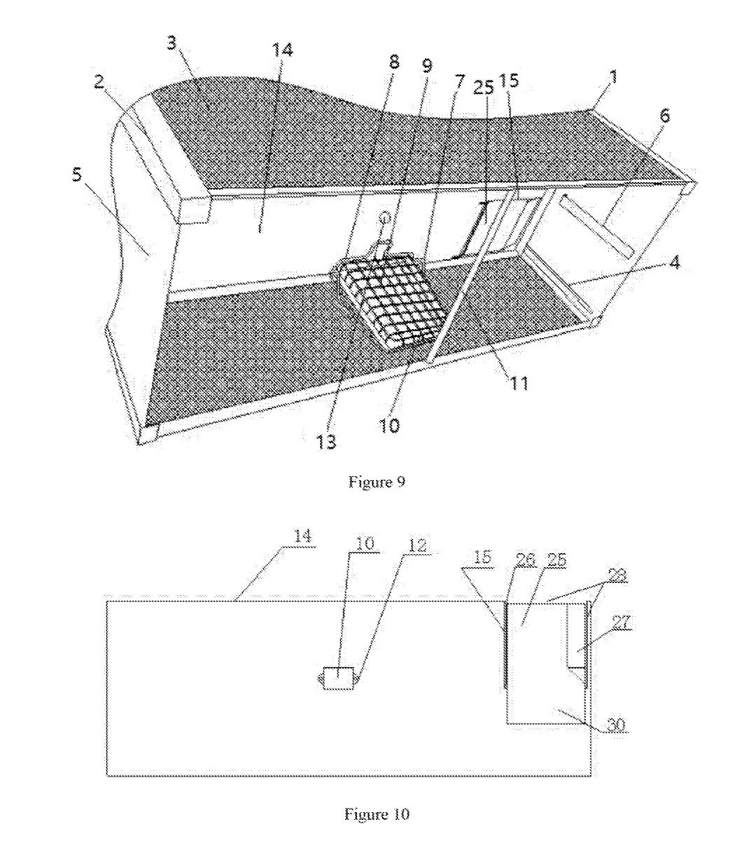

As shown in FIGS. 1-10, a mouse trap 71, includes mouse luring chamber 1 and mouse trapping chamber 22, mouse luring chamber 1 and mouse trapping chamber 22 are designed integrally and divided by partition plate 14. The edges of mouse luring chamber 1 and mouse trapping chamber 22 are connected by L-shaped bordures 2, and cage wall 3 is provided at all sides of mouse luring chamber 1 and mouse trapping chamber 22. There are openings in the two sides of mouse luring chamber 1 and guiding rods 4 are welded at two sides of the openings. An automatic door 5 is provided between guiding rod 4 and U-shaped bordures 2. An U-shaped flexible piece 6 is welded on automatic door 5. An end of flexible piece 6 is welded onto automatic door 5, and the other end of flexible piece 6 goes beyond automatic door 5 to another side thereof. The bottom of mouse luring chamber 1 is open and iron wire 11 is welded on the bottom. Infrared thermal sensor 10 is provided on partition plate 14 and is fixed by connector 12. Infrared hole 13 is provided in partition plate 14 under infrared thermal sensor 10.

Clamp frame 7 is welded onto the inner side of mouse luring chamber 1. Bait box 8 is provided inside clamp frame 7. Mesh 9 is provided on one side of bait box 8. Pulley 19 is provided at each upper end of mouse trapping chamber 22, and wire stand 20 is provided below pulley 19. Entrance 15 is provided in partition plate 14 between mouse luring chamber 1 and mouse trapping chamber 22. Mouse guiding channel 23 is welded inside mouse trapping chamber 22. An end of mouse guiding channel 23 is inlet 24 and first door 25 is rotationally installed at inlet 24 by horizontal rod 26. Upturned piece 27 is provided on the other side of first door 25 parallel to horizontal rod 26. Upturned piece 27 and first door 25 are arranged at an angle over 90 degrees. There are gaps 28 between upturned piece 27 and one side of first door 25 and between the one side of first door 25 and cage wall 3. The one side of first door 25 is placed on limiting piece 29 on cage wall 3. Extended piece 30 extends from the other side of first door 25. Second door 31 is rotationally connected to rouse guiding channel 23. First brace rod 32 is welded onto second door 31. First brace rod 32 goes upward and through mouse guiding channel 23 and contacts switch 33. Baffle plate 34 is provided in mouse guiding channel 23 at front end of second door 31. Cage placement opening 16 is provided in the side face of mouse trapping chamber 22. Several guiding rails 1 are provided inside rouse trapping chamber 22 and correspond to cage placement opening 16.

Mouse storage chamber 51 is placed into cage placement opening 16 through guiding rails 17. Opening 52 is provided on one side of mouse storage chamber 51. Round rod 53 is provided above opening 52. Third door 54 is rotationally connected to round rod 53. Block rod 55 is rotationally connected to the inner wall of mouse storage chamber 51. Block rod 55 goes outside of mouse storage chamber 51 through groove 56. Outer frame 35 is provided on the upper surface of mouse guiding channel 23. Power supply 50 is provided beside outer frame 35. First electric motor 36 is provided inside outer frame 35.

Sleeved rod 38 is connected to first electric motor 36, and sleeved rod 38 is locked into sleeve-block rod 37 on first electric motor 36. Take-up pulley 39 is provided on sleeved rod 38. Limit switch 42 is installed on outer frame 35 beside take-up pulley 39. Second brace rod 43 is provided on limit switch 42. Two first pulling strings 40 are connected to take-up pulley 39. Bead 41 is provided on first pulling string 40 on a side of mouse storage chamber 51. Two first pulling strings 40 go through pulley 19 and wire stand 20 and then are connected to flexible piece 6 on automatic door 5. Vertical piece 44 is further provided on outer frame 35. The middle portion of linkage piece 45 is connected to vertical piece 44. One end of linkage piece 45 is connected to second pulling string 48, and the other end of linkage piece 45 is located below take-up pulley 39. U-shaped limit sleeved rod 49 is provided on outer frame 35 at the junction of linkage piece 45 and second pulling string 48. Linkage piece 45 goes through limit sleeved rod 49. Torsion spring 46 is connected to the junction of linkage piece 45 and vertical piece 44. One end of torsion spring 46 presses against linkage piece 45, and the other end of torsion spring 46 is caught by vertical piece 44.

One end of second pulling string 48 is connected to linkage piece 45, and the other end of second pulling string 48 is connected to the reel rod on second electric motor 47 on the lower surface of outer frame 35. Start switch 21 is provided on the surface of cage wall 3. Mouse trapping chamber 22 and mouse storage chamber 51 are both provided with handles 18. Flexible piece 6 is in a shape of “L” and the base line of “L” is within edges of partition plate 14. Mouse guiding channel 23 corresponds to opening 52 of mouse storage chamber 51 at second door 29. Block rod 55 contacts third door 54. First pulling string 40 at limit switch 42 goes through second brace rod 43, Linkage piece 45 is rotationally connected to vertical piece 44. Wires are provided between infrared thermal sensor 10 and second electric motor 47, between limit switch 42 and first electric motor 36, between limit switch 42 and second electric motor 47, between start switch 21 and first electric motor 36, between switch 32 and first electric motor 36, between power supply 50 and second electric motor 47, and between power supply 50 and first electric motor 36. Fourth door 57 is hinged to mouse trapping chamber 22 above outer frame 35. Start switch 21 of the invention is connected to first electric motor 36.

In the process of trapping the mouse, mouse luring chamber 1 is placed on the ground upside down. Start switch 21 is pressed by hand and first electric motor 36 runs immediately to drive sleeved rod 38 to rotate so that first pulling string 40 is pulled tightly. When bead 41 on first pulling string 40 drives second brace rod 43 to press against limit switch 42, limit switch 42 is triggered so that first electric motor 36 stops and automatic door 5 connected to first pulling string 40 is opened. Automatic door 5 opens upward by means of the guidance from guiding rod 4. It is in the reset state when flexible piece 6 is static and the end of flexible piece 6 is located within partition plate 14, so that automatic door 5 remains closed when automatic door 5 is pulled and lifted by the hand or mouse. Only when flexible piece 6 is pulled by first pulling string 40, flexible piece 6 presses against automatic door 5, so that automatic door 5 moves upward without interference.

Food baits are put inside bait box 8. Mesh 9 is arranged to make the bait smell good so as to induce the mouse. Bait box 8 is placed within clamp frame 7. If the mouse enters into mouse luring chamber 1 and tries to bite the food, the mouse certainly passes by the area below infrared hole 13 so that it is sensed by infrared thermal sensor 10. Second electric motor 47 is then triggered to drive second pulling string 48 to be rolled on the reel rod. Second pulling string 48 drives linkage piece 45 to move, and linkage piece 45 rotates around vertical piece 44 to raise take-up pulley 39 such that sleeved rod 38 is detached from sleeve-block rod 37. Automatic door 5 falls down by means of its own gravity and mouse luring chamber 1 is closed.

Apart from triggering second electric motor 47 by infrared thermal sensor 10, second electric motor 47 can also be triggered by installing a pedal, a temperature sensor, an active infrared intrusion detector, or radar to detect the mouse, so as to drive second electric motor 47 to pull linkage piece 45, such that sleeved rod 38 on take-up pulley 39 is detached from sleeve-block rod 37. Accordingly, first pulling string 40 moves and automatic door 5 falls down. Since bead 41 leaves second brace rod 43, limit switch 42 makes second electric motor 47 disconnected from the power. Linkage piece 45 is reset by torsion spring 46. The movement of linkage piece 45 is restricted by limit sleeved rod 49, then take-up pulley 39 falls down and sleeved rod 38 is fitted on sleeve-block rod 37 so that take-up pulley 39 is stabilized.

The mouse enters into inlet 24 of mouse guiding channel 23 in mouse trapping chamber 22 through entrance 15 of partition plate 14. Because upturned piece 27 is provided on first door 25, and thus upturned piece 27 looks like a groove with a bigger lower end and a smaller upper end when looking upward from the bottom. Additionally, there are gaps 28 between upturned piece 27 and one side of first door 25, and between the one side of first door 25 and cage wall 3, so that the mouse will run upward and enter into mouse guiding channel 23 through first door 25. If the entered mouse wants to escape through first door 25, the mouse has to set foot on extended piece 30 due to the design of extended piece 30, so that the mouse cannot raise first door 25. Upturned piece 27 is integrally designed and will not deform due to the attempts of the mouse. First door 25 will not deform and get damaged when the mouse walks on first door 25, because of the supports from limiting piece 29 and extended piece 30. The captured mouse continues to walk in mouse guiding channel 23 and pushes second door 31 open, so that first brace rod 32 on second door 31 triggers switch 33 to operate electric motor 36. Take-up pulley 39 is then driven to rotate, so as to pull first pulling string 40 tightly and automatic door 5 is opened again for capturing another mouse.

Baffle plate 34 is provided to prevent the mouse from returning and trying to open second door 31. If the mouse returns to mouse guiding channel 23, the mouse will set foot on second door 31 and thus have no chance to open second door 31 and thus escape from second door 31. At the same time, bead 41 contacts second brace rod 43 and limit switch 42 is switched on, so that second electric motor 47 is connected to the power. The mouse pushes third door 54 and enters into mouse storage chamber 51 through mouse guiding channel 23 corresponding to opening 52. The next day, the user can check the capture status. Block rod 55 is turned downward, such that block rod 55 presses against third door 54 and all the captured mice are put in mouse storage chamber 51. The user can put mouse storage chamber 51 in water to drown the mice for easy processing, which is very convenient. Mouse luring chamber 1 is designed to be open and the bottom is the same as the ground for daily walk, and hence it's easy to induce the mouse in. Otherwise, if the bottom is provided as a plate, the mouse is on the alert.

The skilled in the art should understand that the invention is not limited to the above embodiments. What are described in the above embodiments and the description are just the principles of the invention. Without departing from the spirit and scope of the invention, various modifications and improvements can be made to the invention, and all the modifications and improvements fall into the protection scope of the invention. The protection scope is defined by the appended claims and the equivalents thereof.

What is claimed is:

1. A mouse trap, comprising:
a mouse luring chamber and a mouse trapping chamber,
wherein the mouse luring chamber and the mouse trapping chamber are designed integrally and divided by a partition plate, edges of the mouse luring chamber and the mouse trapping chamber are connected by L-shaped bordures, and a cage wall is provided at all sides of the mouse luring chamber and the mouse trapping chamber,
wherein there are openings in the two sides of the mouse luring chamber and guiding rods are welded at two sides of the openings, an automatic door is provided between the guiding, rod and the L-shaped bordures, an L-shaped flexible piece is welded on the automatic door, one end of the flexible piece is welded onto the automatic door, and the other end of the flexible piece extends through the automatic door to another side thereof,
wherein a bottom of the mouse luring chamber is open and an iron wire is welded on the bottom, an infrared thermal sensor is provided on the partition plate and is fixed by a connector, an infrared hole is provided in the partition plate under the infrared thermal sensor, a clamp frame is welded onto an inner side of the mouse luring chamber, a bait box is provided inside the clamp frame, a mesh is provided on one side of the bait box,
wherein a pulley is provided at an upper end of the mouse trapping chamber, and a wire stand is provided below the pulley, an entrance is provided in the partition plate between the mouse luring chamber and the mouse trapping chamber, a mouse guiding channel is welded inside the mouse trapping chamber, an end of the mouse guiding channel is an inlet and a first door is rotationally installed at the inlet by a horizontal rod, an upturned piece is provided on another side of the first door parallel to the horizontal rod,
wherein the upturned piece and the first door are arranged at an angle over 90 degrees, there are gaps between the upturned piece and one side of the first door, and between the one side of first door and the cage wall, the one side of the first door is placed on a limiting piece on the cage wall, an extended piece extends from the other side of the first door,
wherein a second door is rotationally connected to the mouse guiding channel, a first brace rod is welded onto the second door, the first brace rod goes upward and through the mouse guiding channel and contacts a switch, a baffle plate is provided in the mouse guiding channel at a front end of the second door, a cage placement opening is provided in a side face of the mouse trapping chamber, several guiding rails are provided inside the mouse trapping chamber and correspond to the cage placement opening, a muse storage chamber is placed into the cage placement opening through the guiding rails,
wherein an opening is provided in one side of the mouse storage chamber, a round rod is provided above the opening, a third door is rotationally connected to the round rod, a block rod is rotationally connected to an inner wall of the mouse storage chamber, the block rod extends outside of the mouse storage chamber through a groove, an outer frame is provided on an upper surface of the mouse guiding channel, a power supply is provided beside the outer frame, a first electric motor is provided inside the outer frame, a sleeved rod is connected to the first electric motor, and the sleeved rod is locked into a sleeve-block rod, a take-up pulley is provided on the sleeved rod, a limit switch is installed on the outer frame beside the take-up pulley,
wherein a second brace rod is provided on the limit switch, two first pulling strings are connected to the take-up pulley, a bead is provided on a first pulling string on the side of the mouse storage chamber, the two first pulling strings go through the pulley and the wire stand, and then are connected to a flexible piece on the automatic door, a vertical piece is further provided on the outer frame, a middle portion of a linkage piece is connected to the vertical piece, one end of the linkage piece is connected to a second pulling string, and an other end of the linkage piece is located below the take-up pulley,
a U-shaped limit sleeved rod is provided on the outer frame at a junction of the linkage piece and the second pulling string, the linkage piece extends through the limit sleeved rod, a torsion spring is connected to a junction of the linkage piece and the vertical piece, one end of the torsion spring presses against the linkage piece, and the other end of the torsion spring is caught by the vertical piece, one end of the second pulling string is connected to the linkage piece, and the other end of the second pulling string is connected to a reel rod on a second electric motor on a lower surface of the outer frame, and a start switch is provided on a surface of the cage wall.

2. The mouse trap of claim 1, wherein the mouse trapping chamber and the mouse storage chamber are both provided with handles.

3. The mouse trap of claim 1, wherein the flexible piece is in a shape of “L” and a base line of “L” is within edges of the partition plate.

4. The mouse trap of claim 1, wherein the mouse guiding channel corresponds to the opening of the mouse storage chamber at the second door.

5. The mouse trap of claim 1, wherein the block rod contacts a third door.

6. The mouse trap of claim 1, wherein the first pulling string at the limit switch extends through the second brace rod.

7. The mouse trap of claim 1, wherein the linkage piece is rotationally connected to the vertical piece.

8. The mouse trap of claim 1, wherein wires are provided between the infrared thermal sensor and the second electric motor, between the limit switch and the first electric motor, between the limit switch and the second electric motor, between the start switch and the first electric motor, between the switch and the first electric motor, between the power supply and the second electric motor, and between the power supply and the first electric motor.

9. The mouse trap of claim 1, wherein a fourth door is hinged to the mouse trapping chamber above the outer frame.
